(19) United States
(12) Patent Application Publication
(10) Pub. No.: US 2016/0352078 A1
(43) Pub. Date: Dec. 1, 2016

(54) FOULING RESISTANT SPARK PLUG

(71) Applicant: Fram Group IP LLC, Lake Forest, IL (US)

(72) Inventors: Ronald Rohrbach, Flemington, NJ (US); Peter D. Unger, Morristown, NJ (US); Jeffrey T. Boehler, Holland, OH (US); Jing Zheng, Findlay, OH (US)

(21) Appl. No.: 15/218,892

(22) Filed: Jul. 25, 2016

Related U.S. Application Data
(63) Continuation of application No. 13/469,837, filed on May 11, 2012, now abandoned.

(51) Int. Cl. H01T 13/14; H01T 13/38

(52) U.S. Cl. CPC H01T 13/14; H01T 13/38

(57) ABSTRACT

Disclosed herein is a spark plug comprising an insulative sleeve. A glaze coating is disposed on the exterior surface of the insulative sleeve. The glaze coating comprises a silicate glass, a phosphorous glass, a borosilicate glass, or a combination of the foregoing glasses wherein the glasses are independently modified with a modifier selected from the group consisting of alkali group metals, alkali earth group metals, aluminum, and a combination of two or more of the foregoing modifiers and further wherein the glaze coating has a glass transition temperature (Tg) of 300 to 1000 degrees Celsius.

### BACKGROUND OF THE INVENTION

This is a continuation of prior Application No. 13/469,837, entitled “Fouling Resistant Spark Plug,” filed May 11, 2012. The entire contents of application Ser. No. 13/469,837 is incorporated herein by reference.

The subject matter disclosed herein relates to a spark plug and in particular to an insulator of a spark plug.

Spark plugs used as igniters in an internal combustion engine are subjected to a condition known as “fouling.” Over time, carbon and other products of combustion can accumulate on the surface of the insulator tip, which is typically positioned at or near the boundary of unmixed fuel. The products of combustion of a gasoline engine include fuel additive components such as methylcyclopentadienyl manganese tricarbonyl (MMT) and ferrocene which are often added to gasoline as an octane enhancement. Because the exposed surface of the insulator tip is not located in or about the spark gap, accumulated combustion soot may not be burned off. If significant amounts of these combustion products are accumulated, the spark may not properly form between the center and ground electrodes. The accumulated combustion products create an electrical short circuit such that the charge from the center electrode travels across the surface of the insulator and back to the outer metal shell.

Accordingly, while existing spark plugs are suitable for their intended purposes, the need for improvement remains, particularly in providing a spark plug that is more resistant to fouling caused by the accumulation of combustion products on the insulator tip.

### BRIEF DESCRIPTION OF THE INVENTION

Disclosed herein is a spark plug 10 comprising an insulative sleeve 14 having a central axial bore 16 and an exterior surface 46 and a center electrode 32 extending through the central axial bore 16 of the insulative sleeve 14. The insulating sleeve 14 is positioned within, and secured to, a metal shell 12 that serves as a mounting platform and interface to an internal combustion engine. The metal shell 12 also supports a ground electrode 22 that is positioned in a spaced relationship relative to the center electrode 32 so as to generate a spark gap. The insulating sleeve 14 includes a shaped tip portion 42 that resides in a recessed end portion 24 of the metal shell 12. A glaze coating 48 is disposed on the exterior surface 46 of the insulative sleeve 14. The glaze coating 48 comprises a silicate glass, a phosphorous glass, a borosilicate glass, or a combination of the foregoing glasses wherein the glasses are comprise a modifier selected from the group consisting of alkali group metals, alkali earth group metals, aluminum, and combinations of two or more of the foregoing modifiers and further wherein the glaze coating has a glass transition temperature (Tg) of 300 to 1000 degrees Celsius.

Also disclosed herein are methods of making the spark plug 10 comprising the coated insulative sleeve 14.

### BRIEF DESCRIPTION OF THE DRAWINGS

Referring now to the figure, which is an exemplary embodiment:

FIG. 1 is a cross-sectional view of an exemplary embodiment of a spark plug of the present disclosure.

### DETAILED DESCRIPTION OF THE INVENTION

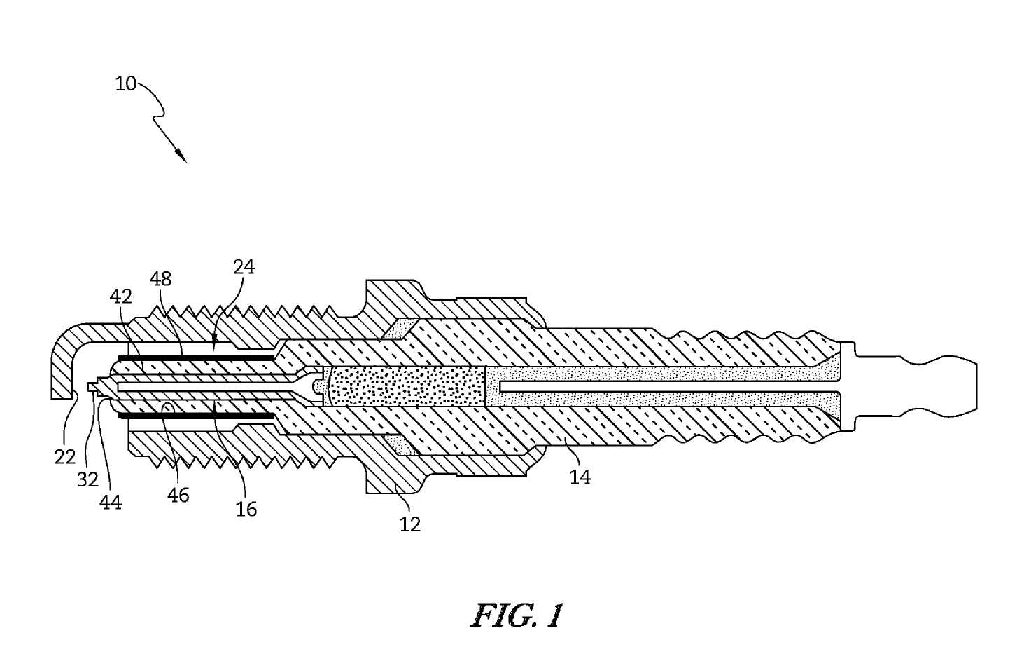

The glaze coating 48, as described herein, can be a continuous or discontinuous coating. The glaze coating 48 can initially be continuous (i.e., no breaks or gaps visible to the naked eye) but may evolve breaks and/or gaps with use. As shown in FIG. 1, in one embodiment the glaze coating 48 is continuous and forms a band around the insulative sleeve 14. The band is located 0.1 to 5 millimeters (mm) from the top edge 44 of the insulative sleeve 14. The top edge 44 of the insulative sleeve 14 is the edge located closest to the central electrode 32 protruding through the central bore of the insulative sleeve 14. The glaze coating band 48 can have a width of 1 to 20 mm. The width of the band 48 can depend on the insulator design and can be determined by one of skill in the art. It is contemplated that multiple bands can be employed. The glaze coating thickness can be 1 to 500 micrometers, or, more specifically 10 to 100 micrometers.

Without being bound by theory, it is believed that the glaze coating prevents and/or reduces adhesion of MMT deposits on the spark plug. Also, the glaze coating may result in a surface that is more resistant to black soot discoloration and hence is possibly more resistant to carbon soot fouling/buildup than the untreated insulative sleeve. The glaze coating may function by dissolving the MMT deposit in the glaze coating, thereby preventing and/or reducing adhesion of the MMT deposit to the insulative sleeve and reducing or eliminating electrical conductivity (increasing electrical resistance) compared to an untreated sleeve with an equivalent amount of MMT deposit. This approach to solving the problem of MMT deposits is complicated by several factors, including the fact that MMT deposit composition varies along the length of the spark plug and when the MMT deposit dissolves in the glaze coating it alters the composition and the properties of the glaze coating. Other challenges to solving the problem of MMT deposits include minimizing volatility of the glaze coating at the operating temperature of the spark plug coupled with having a glaze coating composition with a glass transition temperature appropriate to assist with solvating the MMT deposit. Additionally viscosity of the glaze coating at the operating temperature of the spark plug must be adequate to prevent the glaze coating from slipping to an undesired location on the spark plug. As used herein the term “MMT deposit” refers to the composition deposited on the spark plug in an engine using gasoline comprising MMT.

The glaze coating comprises a silicate glass, a phosphorous glass, a borosilicate glass, or a combination of the foregoing modified glasses wherein the glasses comprise a modifier selected from the group consisting of alkali group metals, alkali earth group metals, aluminum, and a combination of two or more of the foregoing modifiers and further wherein the glaze coating has a glass transition temperature (Tg) of 300 to 1000 degrees Celsius. Within this range, the Tg may be greater than or equal to 450 degrees Celsius. Also within this range, the Tg may be less than or equal to 950 degrees Celsius. In one embodiment the glaze comprises a phosphorous glass, a borosilicate glass, or a combination thereof, wherein the glass comprises a modifier selected from the group consisting of alkali group metals, alkali earth group metals, aluminum, and a combination of two or more of the foregoing modifiers.

As mentioned above the glaze coating can optionally include an inorganic filler. The filler can be chosen to have a decomposition temperature greater than or equal to 1200° C., or, more specifically, greater than or equal to 1400° C. The filler can also be chosen to have an average particle size (as determined by the longest linear dimension) of less than or equal to 13 micrometers. Within this range, the average particle size can be 5 nanometers to 10 micrometers.

Exemplary fillers include silica, fumed silica, hydrophilic fumed silica, wollastonite, organoclay, natural clay, alumina, and combinations of the foregoing.

The glaze coating has a Tg of 300 to 1000 degrees C. Within this range, the softening temperature can be greater than or equal to 450 degrees C. Also within this range, the softening temperature can be less than or equal to 950 degrees C.

The glaze coating is formed by applying a dispersion of the glaze coating components. Useful carriers for the dispersion include water, alcohol, mineral spirits, acetone and the like. The dispersion is applied to the insulative sleeve of a spark plug subassembly. A spark plug subassembly comprises an insulative sleeve, center electrode, resistor, and terminal stud end. The dispersion can be applied by any appropriate method such as painting, dip coating, spray coating, and the like. Any coating applied to the center electrode can be removed by an appropriate method.

The applied dispersion is allowed to air dry, optionally under air flow, at room temperature for at least 15 minutes, or, more specifically, 1 to 4 hours. After air drying the subassembly is then treated at an elevated temperature, such as 650 to 1100 degrees C. for 20 minutes to 5 hours, or, more specifically, 0.5 to 2 hours. The length of time at the elevated temperature should be chosen to be sufficient to form a glaze coating.

The electrical resistivity of the insulative sleeve comprising a glaze coating can be greater than or equal to 1×10⁶ ohms/mm, or, more specifically, greater than or equal to 1×10⁷ ohms/mm, or, more specifically, greater than or equal to 2×10⁷ ohms/mm, prior to use in an engine. After use in an engine using gasoline comprising MMT the insulative sleeve comprising a glaze coating may have an electrical resistivity greater than or equal to 1×10⁶ ohms/mm.

The invention is further illustrated by the following non-limiting examples.

### EXAMPLES

Insulative sleeves available from Autolite were coated with a 22 weight percent dispersion of one of three glaze coatings in acetone. Weight percent is based on the total weight of the dispersion. The glaze coatings are shown in Table 1. VIOX 17930 comprises a silicate glass comprising Al, B, Mg, Ca, and Sr as modifiers and is commercially available from Viox. Mod-3 comprises a borosilicate glass comprising Ba, Sr, Mg, Ca, and Na as modifiers and is commercially available from Viox. The glaze coating was applied as a band starting approximately 1 mm from the top edge of the insulative sleeve and continuing to the gasket seal location on insulator. The insulative sleeves were then air dried for 1 hour and then heated to 850 degrees Celsius and held at that temperature for 1 hour. The insulative sleeve was then combined with the remaining elements to form a spark plug. The spark plugs were tested in an accelerated road test. The spark plugs were put into service in a van using gasoline having 36 ppm MMT. The spark plugs were in service for 3700 miles or 6900 miles and then tested for electrical resistivity using Fostoria Shunt Resistance Analysis. Control spark plugs having no glaze coating were also tested. Results are shown in Table 1. The shunt resistances were measured between center electrode and metal shell of the sparkplug. The resistance measurements were taken after sparkplug assembly was held at 300 degrees C. for 1 hour.

TABLE 1

| | | | Shunt |
|---|---|---|---|
| Example | Coating | Mileage | Resistance |
| Control A | None | 3700 miles | 4.8 giga ohms |
| Control B | None | 6900 miles | 2.4 giga ohms |
| 1 | 35 weight percent VIOX | 3700 miles | Greater than |
| | 17930/65 weight percent Mod-3 | | 11 giga ohms |
| 2 | 35 weight percent VIOX | 6900 miles | Not |
| | 17930/65 weight percent Mod-3 | | Determined |
| 3 | Mod-3 | 3700 | 5.9 giga ohms |
| 4 | VIOX 17930 | 6900 | 4.6 giga ohms |

As can be seen from the Results in Table 1, the presence of a glaze coating greatly improves (increases) the resistivity of the insulative sleeve when used in engine using gasoline containing MMT.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A spark plug comprising
an insulative sleeve having a central axial bore and an exterior surface, wherein a glaze coating is disposed on the exterior surface, wherein the glaze coating is a continuous band located 0.1 to 5 millimeters from a top edge of the insulative sleeve, the band having a width of 1 to 20 mm, and wherein the glaze coating comprises a silicate glass, a phosphorous glass, a borosilicate glass, or a combination of the foregoing glasses, wherein the glasses are independently modified with a modifier selected from the group consisting of alkali metals,alkaline earth metals, aluminum, and a combination of two or more of the foregoing modifiers, and an inorganic filler wherein the inorganic filler comprises at least one of the group consisting of fumed silica, hydrophilic fumed silica, and wollastonite; a center electrode extending through the central axial bore of the insulative sleeve and having a firing tip that extends beyond the top edge of the insulative sleeve;
a metal shell, wherein the insulative sleeve is positioned within, and secured to, the metal shell; and
a ground electrode supported by the metal shell and positioned in a spaced relationship relative to the center electrode so as to generate a spark gap.

2. The spark plug of claim 1, wherein the glaze coating has a glass transition temperature of 450 to 950 degrees Celsius.

3. The spark plug of claim 1, wherein the glaze coating has a thickness of 1 to 500 micrometers.

4. The spark plug of claim 1, wherein the glaze coating further comprises an inorganic filler.

5. The spark plug of claim 1, wherein the insulative sleeve has a resistivity of greater than or equal to 1×10⁶ ohms/mm prior to use in an engine.

6. A spark plug comprising:
an insulative sleeve having a central axial bore and an exterior surface, wherein a plurality of glaze coating components are dispersed in alcohol, mineral spirits, acetone, or combinations thereof and applied to the exterior surface as a glaze coating, wherein the glaze coating is a continuous band located 0.1 to 5 millimeters from a top edge of the insulative sleeve, the band having a width of 1 to 20 mm, wherein the glaze coating comprises a silicate glass, a phosphorous glass, a borosilicate glass, or a combination of the foregoing glasses, wherein the glasses are independently modified with a modifier selected from the group consisting of alkali metals, alkaline earth metals, aluminum, and a combination of two or more of the foregoing modifiers, wherein the glaze coating further comprises an inorganic filler having a decomposition temperature greater than or equal to 1200 degrees Celsius, and wherein the glaze coating has a glass transition temperature (Tg) of 300 to 1000 degrees Celsius;
a center electrode extending through the central axial bore of the insulative sleeve, and having a firing tip that extends beyond the top edge of the insulative sleeve;
a metal shell, wherein the insulating sleeve is positioned within, and secured to, the metal shell; and
a ground electrode supported by the metal shell and positioned in a space relationship relative to the center electrode so as to generate a spark gap.

7. The spark plug of claim 6, wherein the glaze coating has a glass transition temperature of 450 to 950 degrees Celsius.

8. The spark plug of claim 6, wherein the glaze coating has a thickness of 1 to 500 micrometers.

9. The spark plug of claim 6, wherein the insulative sleeve has a resistivity of greater than or equal to 1×10⁶ ohms/mm prior to use in an engine.

10. The spark plug of claim 6, wherein the decomposition temperature of the inorganic filler is greater than or equal to 1400 degrees Celsius.

11. The spark plug of claim 6, wherein an average particle size as determined by a longest linear dimension of the inorganic filler is less than or equal to 13 micrometers.

12. The spark plug of claim 10, wherein the average particle size of the inorganic filler is between 5 nanometers and 10 micrometers.

13. The spark plug of claim 6, wherein the inorganic filler is selected from the group consisting of fumed silica, hydrophilic fumed silica, wollastonite, and combinations thereof.

14. The spark plug of claim 4, wherein the inorganic filler is selected from the group consisting of fumed silica, hydrophilic fumed silica, wollastonite, and combinations thereof.

15. A spark plug comprising:
an insulative sleeve having a central axial bore and an exterior surface, wherein a glaze coating is disposed on the exterior surface, wherein the glaze coating is a continuous band located 0.1 to 5 millimeters from a top edge of the insulative sleeve, the band having a width of 1 to 20 mm, wherein the glaze coating comprises a silicate glass, a phosphorous glass, a borosilicate glass, or a combination of the foregoing glasses, wherein the glasses are independently modified with a modifier selected from the group consisting of alkali metals, alkaline earth metals, aluminum, and a combination of two or more of the foregoing modifiers, and wherein the glaze coating has a glass transition temperature (Tg) of 300 to 1000 degrees Celsius;
a center electrode extending through the central axial bore of the insulative sleeve and having a firing tip that extends beyond the top edge of the insulative sleeve;
a metal shell, wherein the insulative sleeve is positioned within, and secured to, the metal shell; and
a ground electrode supported by the metal shell and positioned in a spaced relationship relative to the center electrode so as to generate a spark gap;
wherein the glaze coating is a continuous band located 0.1 to 5 millimeters from the top edge of the insulative sleeve.

16. The spark plug of claim 1, wherein an average particle size as determined by a longest linear dimension of the inorganic filler is less than or equal to 13 micrometers.

17. The spark plug of claim 16, wherein the average particle size of the inorganic filler is between 5 nanometers and 10 micrometers.
